(19) United States
(12) Patent Application Publication
(10) Pub. No.: US 2016/0173685 A1
(43) Pub. Date: Jun. 16, 2016

(54) SECURE CALLER IDENTIFICATION USING A PROFILE

(71) Applicant: International Business Machines Corporation, Armonk, NY (US)

(72) Inventors: Alwyn R. Lobo, Bangalore (IN); Rajath Ramesh, Karnataka (IN); Panibhushan Shivaprasad, Bangalore (IN)

(21) Appl. No.: 14/831,093

(22) Filed: Aug. 20, 2015

Related U.S. Application Data
(63) Continuation of application No. 14/568,595, filed on Dec. 12, 2014.

(51) Int. Cl. H04M 3/42; H04L 29/06; H04L 29/08

(52) U.S. Cl. CPC H04M 3/42068; H04L 67/306; H04L 63/12

(57) ABSTRACT

A first login information for a first user is received. A first user profile associated with the first login information for the first user is received. A call from the first user placed to a second user is intercepted. If the first login information verifies the identity of the first user is determined. Responsive to determining the first login information verifies the first user, the first user profile is transmitted to the second user causing the call from the first user placed to the second user to be forwarded to the second user.

### BACKGROUND OF THE INVENTION

The present invention relates generally to the field of caller identification, and more particularly to secure caller identification using a caller's profile prior to forwarding a call from a first user to a second user.

A mobile phone, also known as a cellular phone, cell phone, hand phone, or simply a phone, is a phone that can make and receive telephone calls over a radio link while moving around a wide geographic area. The phone connects via a cellular network provided by a mobile phone operator, allowing access to the public telephone network. A user receives a call from a party, and upon receiving the call, the user may have an indication of a phone number that is calling the user. A profile, in the called party's phone, can indicate, based on the phone number calling, who is calling the called party. Often, a phone number will be displayed with no profile attached to the number.

### SUMMARY

Embodiments of the present invention include a method, computer program product, and system for providing a secure caller identification using a caller's profile. In one embodiment, a first login information for a first user is received. A first user profile associated with the first login information for the first user is received. A call from the first user placed to a second user is intercepted. If the first login information verifies the first user is determined. Responsive to determining the first login information verifies the identity of the first user, the first user profile is transmitted to the second user causing the call from the first user placed to the second user to be forwarded to the second user.

### BRIEF DESCRIPTION OF THE DRAWINGS

FIG. 1 is a functional block diagram of a data processing environment, in accordance with an embodiment of the present invention;

FIG. 2 is a flowchart depicting operational steps of a program for secure caller identification using a profile, in accordance with an embodiment of the present invention; and

FIG. 3 depicts a block diagram of components of a computing system representative of the computers of FIG. 1, in accordance with an embodiment of the present invention.

### DETAILED DESCRIPTION

As people become more connected to their devices, people receive more and more calls from numbers that are unknown to the party receiving the call. Often, people are in meetings and receive a phone call and it is unknown to them whether the call is something important or just another telemarketer that they want to avoid. Additionally, people can receive calls from unknown numbers in the cases of someone hacking a phone number or in scams where the calling party pretends to be someone they are not to persuade the party receiving the call to give the caller money. Also, with the growing use of internet/computer applications to make phone calls, often the receiving party will see a random or “private” number as the caller. Ignoring the phone call in all these instances runs the risk of missing an important phone call or an emergency call made by someone the called party knows but the number is unknown.

Some embodiments of the present invention recognize that as more people become connected to their devices, people receive more and more calls from numbers that are unknown to the party receiving the call. Additionally, more and more callers use devices that are not specifically their own, to make calls.

Embodiments of the present invention allow for providing secure caller identification using a caller's profile. Upon initiation of a call by a calling party, login information of the called party is received. Using the login information, a profile of the caller is obtained. The profile of the caller is forwarded, along with the call, to the called party and the called party can choose to accept or reject the phone call.

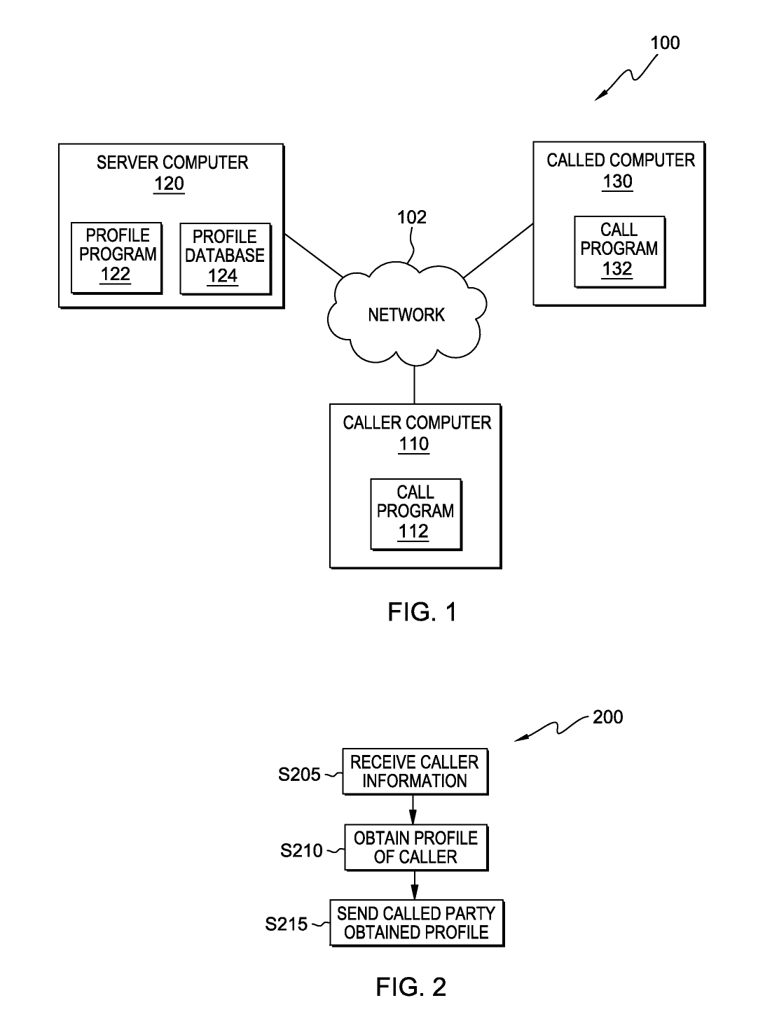

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

An embodiment of data processing environment 100 includes caller computer 110, server computer 120, and called computer 130, interconnected over network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between caller computer 110, server computer 120, and called computer 130, and any other computer connected to network 102, in accordance with embodiments of the present invention. In an embodiment, a telecommunication network can be a cellular or mobile network.

In example embodiments, caller computer 110 and called computer 130 may be a cellular phone or a smart phone. In general, caller computer 110 and called computer 130 are representative of any electronic device or combination of electronic devices capable of executing computer readable program instructions, sending and receiving data, and initiating and receiving telephone calls. In an embodiment, caller computer 110 and called computer 130 can communicate via a mobile network of a telecommunications provider.

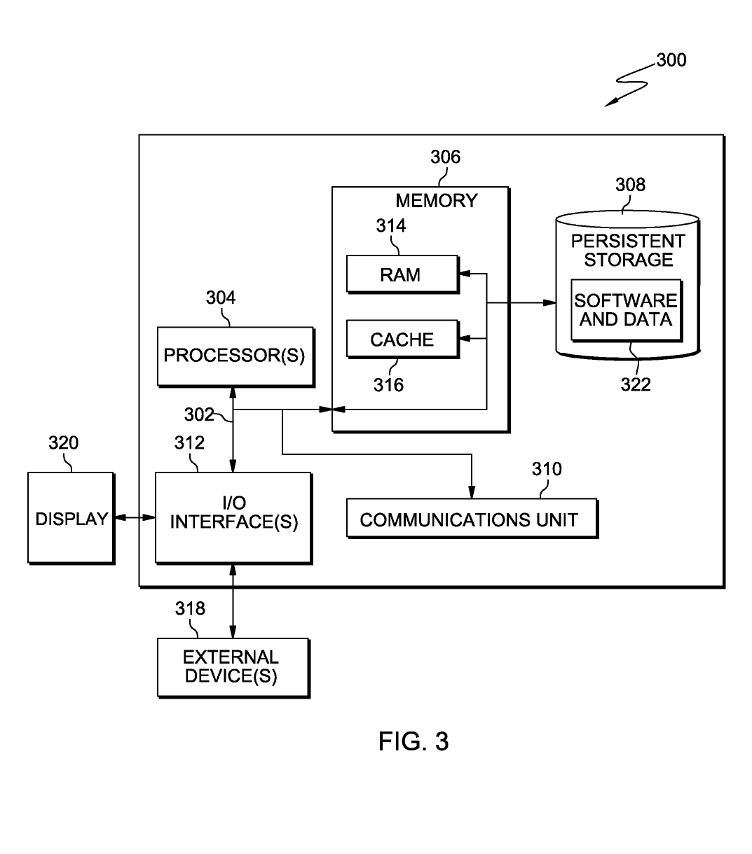

In example embodiments, server computer 120 may be a laptop, tablet, or netbook personal computer (PC), a desktop computer, a personal digital assistant (PDA), a smart phone, or any programmable electronic device capable of communicating with any computing device within data processing environment 100. In certain embodiments, server computer 120 collectively represents a computer system utilizing clustered computers and components (e.g., database server computers, application server computers, etc.) that act as a single pool of seamless resources when accessed by elements of data processing environment 100, such as in a cloud computing environment. In general, server computer 120 is representative of any electronic device or combination of electronic devices capable of executing computer readable program instructions. In an embodiment, server computer 120 is found on a mobile network of a telecommunication provider. Server computer 120 may include components as depicted and described in further detail with respect to FIG. 3, in accordance with embodiments of the present invention.

Caller computer 110 includes call program 112. In an embodiment, call program 112 is a program, application, or subprogram of a larger program that provides login identification verification for a user of caller computer 110 and then, upon initiation of a call by a verified user, sends the user's identification information to profile program 122.

In an embodiment, call program 112 is a security feature that verifies the identity of the user of caller computer 110 and sends the login information of the user, when the user makes a call, to profile program 122. For example, call program 112 may be an application in a smart phone and when a user opens call program 112 the user can be required to sign in to the call program 122 with his or her identification before making a call. There exists multiple different sign in categories. In an embodiment sign in category may be “Social Network” where the identification used is the login credentials for any social network. In other words, the login identification can be verified via the social network login protocol. In an alternative embodiment, the sign in in category may be “Biometric” where the identification used may be biometric identification information, such as a fingerprint, retina pattern, etc. In yet another alternative embodiment, the sign in category may be “Existing Account” where the user may have previously setup an account, or prepopulated an account, with the mobile network provider and the user has a login and associated password, for example a pin number. In yet another alternative embodiment, the sign in category may be “Unique Identification Number” where the user identification may be a unique identification number of the user, such as a Social Security Number.

In an embodiment, call program 112 receives the identification information and sends the sign in category and identification information to profile program 122 with the call details. Profile program receives the sign in category and checks the received identification information with identification information stored in profile database 124 to verify the user's identity. If the user's identification information is not contained in profile database 124, then an identification request can be sent, via network 102, to the appropriate source system based on the sign in category with the identification information to obtain the user's profile. For example, the source system can be a specific social network if the sign in category is “Social Network”, the source system can be a Government SSN Database if the sign in category is “Unique Identification Number”, etc. The obtained user's profile will be sent to the called party, so that the called party can be notified of the actual user who is calling instead of the user who owns the mobile phone. In an embodiment, the user trying to login can be the owner of caller computer 110. In an alternative embodiment, the user trying to login does not have to be the owner of caller computer 110. In other words, Person A can use Person B's cell phone to call Person C, and Person C will know that it is Person A calling them and not Person B.

In an embodiment, upon a user's first use of call program 112, the user, via call program 112, will create a profile that will be stored in profile database 124 and this profile will be sent to a called party. In an embodiment, the user can import their profile directly from any appropriate source system based on the sign in category and the identification information that was used for logging into call program 112. In an alternative embodiment, the user can create a custom profile, including information like name, age, a picture, job title, etc., that is stored in profile database 124.

A user interface (not shown) is a program that provides an interface between a user and call program 112. A user interface refers to the information (such as graphic, text, and sound) a program present to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

Server computer 120 includes profile program 122 and profile database 124. In an embodiment, profile program 112 is a program, application, or subprogram of a larger program that receives identification information about a caller, retrieves profile information about that caller based on the identification information, and sends the called party the profile information about the calling party. Profile database 124 contains identification information for login verification and profile information about users for sending to call program 132.

In an embodiment, profile program 122 provides a way for a user of caller computer 110 to send their profile information to a called party that is using called computer 130. Profile program receives caller information, for example the previously discussed identification information, for a user of call program 112. Profile program checks the profile database 124 for profile information of the user based on the received user's identification information. If the profile is not found, then the received identification information can be sent, via network 102, to the appropriate source system based on the sign in category with the identification information to obtain the user's profile, as discussed previously. The obtained user profile will be stored in profile database 124 along with the identification information and profile program 122 sends the profile information of the caller to the called party for display on called computer 130 via call program 132. For example, profile program 122 receives identification information about a caller, “Alex Smith”, using call program 112. Profile program 122 retrieves the profile of “Alex Smith” from profile database 124 and then sends the profile information to the called party for display on called computer 130 via call program 132. In an embodiment, the identification and profile information for a user stored in profile database 124 may be purged based on a configurable time interval to avoid the growth in size of profile database 124.

Profile database 124 may include data relating to a user and a profile for the user. Additionally, profile database 124 may include identification information and an associated password, for example a pin number discussed previously, that the user created upon initial setup of the account with the mobile network. In an alternative embodiment, profile database 124 may include biometric identification information of a user, such as a fingerprint, retina pater, etc., as discussed previously. The user is a person that will make a call on caller computer 110 using call program 112. The profile includes information like name, age, a picture, job title, etc., as preprogrammed by the user associated with the profile. Alternatively, the profile includes information for the user from their associated social network.

Profile database 124 resides on server computer 120. In an alternative embodiment, profile database 124 may reside on another device or computer within data processing environment 100 or any other device not within data processing environment 100, accessible via network 102. A database is an organized collection of data. Data found in a database is typically organized to model relevant aspects of reality in a way that supports processes requiring the information found in the database. Profile database 124 can be implemented with any type of storage device capable of storing data that may be accessed and utilized by caller computer 110, such as a database server, a hard disk drive, or a flash memory. In other embodiments, profile database 124 can be implemented with multiple storage devices within computer 110.

Alternatively, profile database 124 can be implemented with any computer readable storage medium as found in the art. For example, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Called computer 130 includes call program 132. In an embodiment, call program 132 is a program, application, or subprogram of a larger program that receives calls and displays profile information of calling parties on a called party's device. Call program 132 has a user interface similar to call program 112.

In an embodiment, call program 132 displays the profile information of a calling party on called computer 130. For example, call program 132 displays on called computer 130 that a call is incoming. Additionally, call program 132 displays the profile information of the caller, as determined and sent by profile program 122. In an embodiment, call program 132 displays this profile information for the user of called computer 130 and the user of called computer 130 can accept or reject the phone call. In an alternative embodiment, call program 132 can have a login identification similar to call program 112 that requires the user of call program 132 on called computer 130 to login to call program 132 before being able to accept or reject the incoming call.

FIG. 2 is a flowchart of workflow 200 depicting operational steps for providing a profile of a calling party to a called party, in accordance with an embodiment of the present invention. In one embodiment, the steps of the workflow are performed by profile program 122. Alternatively, steps of the workflow can be performed by any other program while working with profile program 122. In a preferred embodiment, a user, via a user interface discussed previously, can invoke workflow 200 upon determining that they would like to make a call. In an alternative embodiment, workflow 200 can be invoked automatically under the control of another program, for example, upon the user making a call using call program 112 and the call being sent to profile program 122 to begin a step in workflow 200.

Profile program 122 receives caller information (step S205). As discussed previously, a caller, using caller computer 110, decides to make a call to called party, using called computer 130. In an embodiment, the user logs into call program 112 and call program 112 receives the call information. In other words, call program 112 receives information about who the called party is and how called party can be contacted. Call program 112 sends the call information and identification information with sign in category selected by the user to profile program 122. The identification information is login identification of the caller, as discussed previously, and not profile information that will be introduced in step S210. In an embodiment, profile program 122 receives the identification information from call program 112. In an example, Alex Smith may log into call program 112 on a cell phone and call John Smith, having a phone number of “555-555-5555”. Profile program 122 receives the login information “Alex Smith” and the phone number being called “555-555-5555”.

Profile program 122 obtains the profile of the caller (step S210). As discussed in the previous step, profile program 122 receives the caller identification information along with the sign in category used. In an embodiment, using the received caller identification information, profile program 122, using profile database 124, or appropriate source system based on the sign in category with the user's identification information, obtains the profile of the caller. In other words, caller “Alex Smith” has a profile associated with him that includes a picture of himself, his full name, his title at his employer, his phone number, etc. In an embodiment, this profile information is extracted from a social media profile of a user, as discussed previously. In an alternative embodiment, this profile information is received from the user upon profile setup, as discussed previously.

Profile program 122 sends the called party the obtained profile (step S215). In an embodiment, profile program 122 sends the obtained profile determined in step S210 and possibly modified by the calling party, to call program 132 on called computer 130. The call between caller and called party will be the same as current operations as known in the art, but the profile obtained from step S210 will be displayed on called computer 130 via call program 132. In other words, profile program 122 forwards the call to the called party and transmits the calling party's obtained profile to the called party.

As discussed previously, upon profile program 122 sending the called party the obtained profile, called computer 130 displays the profile information on call program 132. For example, in the case of called computer 130 being a cell phone, the profile information could take up the entire screen with a picture of the caller and their phone number and name. Alternatively, a bar could flash along the bottom of the screen with the caller's name and number in the case of no picture in the profile. In all instances, the called party will have an option to accept the call, reject the call, send the call to voicemail, etc.

FIG. 3 depicts a block diagram of components of computer 300 which is representative of server computer 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computer 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM) 314 and cache memory 316. In general, memory 306 can include any suitable volatile or non-volatile computer readable storage media. Software and data 322 are stored in persistent storage 308 for access and/or execution by processors 304 via one or more memories of memory 306. With respect to computer 110, server computer 120, and called computer 130, software and data 322 includes call program 112, profile program 122, profile database 124, and call program 132.

In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 may include one or more network interface cards. Communications unit 310 may provide communications through the use of either or both physical and wireless communications links. Software and data 322 may be downloaded to persistent storage 308 through communications unit 310.

I/O interface(s) 312 allows for input and output of data with other devices that may be connected to computer 300. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention, e.g., call program 112, can be stored on such portable computer readable storage media and can be loaded onto persistent storage 308 via I/O interface(s) 312. I/O interface(s) 312 also can connect to a display 320.

Display 320 provides a mechanism to display data to a user and may be, for example, a computer monitor. Display 320 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing a secure caller identification using a caller's profile, the method comprising:
receiving, by one or more computer processors, a first login information for a first user;
receiving, by one or more computer processors, a first user profile associated with the first login information for the first user;
intercepting, by one or more computer processors, a call from the first user placed to a second user;
determining, by one or more computer processors, if the first login information verifies the first user; and
responsive to determining the first login information verifies the first user, transmitting, by one or more computer processors, the first user profile to the second user and causing the call from the first user placed to the second user to be forwarded to the second user.

2. The method of claim 1, wherein receiving a first login information for a first user comprises:
receiving, by one or more computer processors, a login identification for the first user associated with a sign in category; and
verifying, by one or more computer processors, whether the received login identification matches a required login identification associated with the sign in category.

3. The method of claim 2, wherein the sign in category is social network, existing account, biometric identification, or unique identification number.

4. The method of claim 3, wherein receiving a first user profile associated with the first login information for the first user comprises:
receiving, by one or more computer processors, the first user profile associated with the sign in category.

5. The method of claim 4, wherein the profile is received from at least one of: a social network, a government database, or a profile database, wherein the profile database is prepopulated by the first user.

6. The method of claim 1, wherein transmitting comprises:
transmitting, by one or more computer processors, the first user profile to the second user via a mobile network and causing the call from the first user placed to the second user to be forwarded to the second user via a mobile network.

7. The method of claim 1, further comprising:
causing the transmitted profile to be displayed to the second user; and
receiving an indication whether the second user accepts the call.
